(19) United States
(12) Patent Application Publication
(10) Pub. No.: US 2023/0393684 A1
(43) Pub. Date: Dec. 7, 2023

(54) TOUCH CONTROL MODULE, TOUCH CONTROL SCREEN AND ELECTRONIC EQUIPMENT

(71) Applicant: WUHAN CHINA STAR OPTOELECTRONICS SEMICONDUCTOR DISPLAY TECHNOLOGY CO., LTD., Wuhan (CN)

(72) Inventor: Junyan HU, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 17/261,038

(22) PCT Filed: Nov. 12, 2020
(86) PCT No.: PCT/CN2020/128306

§ 371 Date: Aug. 27, 2023

(30) Foreign Application Priority Data
Oct. 26, 2020 (CN) 202011155347.5

(51) Int. Cl. G06F 3/041

(52) U.S. Cl. CPC G06F 3/04164; G06F 3/044

(57) ABSTRACT

The present application discloses a touch control module, a touch control display screen, and an electronic device. The touch control module includes: a touch control layer, wherein the touch control layer includes a plurality of touch control groups arranged at intervals, each of the touch control groups includes a plurality of touch control units, and adjacent ones of the touch control units are spaced apart from each other; and a plurality of touch control leads, wherein the touch control leads correspond to the touch control units, one end of one of the touch control leads is connected to a corresponding one of the touch control units, and a total number of a plurality of setting touch control leads between adjacent ones of the touch control groups is less than a preset number.

### BACKGROUND OF INVENTION

### Field of Invention

The present application relates to the field of display technology, in particular to a touch control module, a touch control display screen, and an electronic equipment.

### Description of Prior Art

At present, preparation of the touch control layer in the multi-touch control technology is relatively complicated, and touch control performance in a hovering state will be worse, so it cannot be applied to a large-sized display screen.

### SUMMARY OF INVENTION

### Technical Problem

In order to solve the above problems, single-point touch control technology appeared subsequently. However, in the single-point touch control technology, because there are more touch control leads between adjacent ones of the touch control groups, it will take up more space, making the touch control layer have a large blind area, which reduces sensitivity of a touch control function.

### Technical Solution

The present application provides a touch control module, a touch control display screen, and an electronic device, which can reduce a space occupied by touch control leads and improve sensitivity of a touch control function.

The present application provides a touch control module, including:

a touch control layer, wherein the touch control layer includes a plurality of touch control groups arranged at intervals, each of the touch control groups includes a plurality of touch control units, and adjacent ones of the touch control units are spaced apart from each other;

a plurality of touch control leads, wherein the touch control leads correspond to the touch control units, one end of one of the touch control leads is connected to a corresponding one of the touch control units, a total number of a plurality of setting touch control leads between adjacent ones of the touch control groups is less than a preset number, and the setting touch control leads are touch control leads arranged in a same direction; and

a driving chip connected with another end of the one of the touch control leads.

The present application further provides a touch control display screen, including:

a display module, including a packaging layer; and

the touch control module according to any one of claims 1 to 13, and the touch control layer is provided on the packaging layer.

The present application also provides an electronic device, which includes the above-mentioned touch control display screen.

### Advantageous Effect

Each of the touch control module, touch control screen, and electronic device of the present application includes a touch control layer, wherein the touch control layer includes a plurality of touch control groups arranged at intervals, each of the touch control groups includes a plurality of touch control units, and adjacent ones of the touch control units are spaced apart from each other; a plurality of touch control leads, wherein the touch control leads correspond to the touch control units, one end of one of the touch control leads is connected to a corresponding one of the touch control units, a total number of a plurality of setting touch control leads between adjacent ones of the touch control groups is less than a preset number, and the setting touch control leads are touch control leads arranged in a same direction; and a driving chip connected with another end of the one of the touch control leads, such that a space occupied by the touch control leads can be reduced, and thereby an area of a blind area is reduced, thus improving the sensitivity of the touch control function.

### BRIEF DESCRIPTION OF DRAWINGS

FIG. 1 is a schematic diagram of a first structure of an existing touch control module.

FIG. 2 is a schematic diagram of a second structure of an existing touch control module.

FIG. 3 is a schematic diagram of a structure of an existing touch control lead.

FIG. 4 is a schematic structural diagram of a touch control module provided by an embodiment of the present application.

FIG. 5 is a schematic structural diagram of a touch control module provided by another embodiment of the present application.

FIG. 6 is a schematic structural diagram of a touch control module provided by further another embodiment of the present application.

FIG. 7 is a schematic structural diagram of a touch control module provided by still another embodiment of the present application.

FIG. 8 is a schematic structural diagram of a touch control lead provided by an embodiment of the present application.

FIG. 9 is a schematic structural diagram of a touch control display screen provided by an embodiment of the present application.

### DETAILED DESCRIPTION OF PREFERRED EMBODIMENTS

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references. The spatially relative original translation terms are intended to encompass different orientations in addition to the orientation as depicted in the figures.

The terms “first”, “second”, and “third”, etc. (if present) in the specification and claims of the present disclosure are used to distinguish similar objects, and are not necessarily used to describe a particular order or prioritization. It should be understood that the objects so described are interchangeable where appropriate. Moreover, the terms “including” and “having” and “the” and any synonym thereof, are intended to cover non-exclusive inclusions.

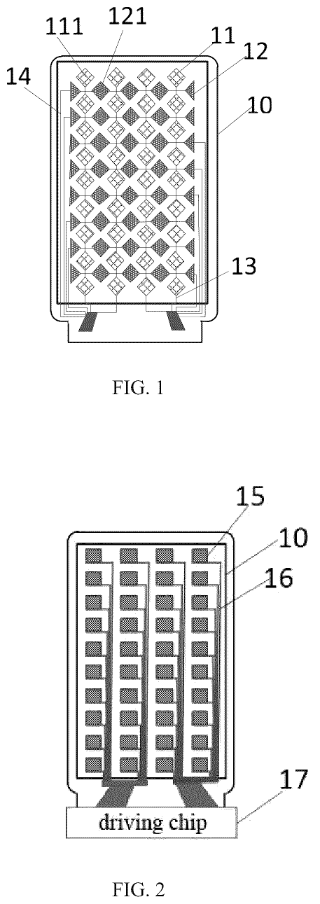

As shown in FIG. 1, a conventional touch control module includes a touch control layer 10, the touch control layer 10 includes a plurality of touch control columns 11 and a plurality of touch control rows 12, the touch control column 11 includes a plurality of first touch control units ill, the touch control row 12 includes a plurality of second touch control units 121, each of the touch control columns 11 is connected to a driving chip through a first touch control lead 13, and each of the touch control rows 12 is connected to a driving chip through a second touch control lead 14.

As shown in FIG. 2, another existing touch control module includes a touch control layer 10, and the touch control layer 10 includes a plurality of touch control units 15, a plurality of touch control leads 16, and a driving chip 17. Adjacent ones of the touch control units 15 are spaced apart from each other, the touch control leads 16 correspond to the touch control units 15 one-to-one, one end of one of the touch control leads 16 is connected to a corresponding one of the touch control units 15, and another end of the one of the touch control leads 16 is connected to the driving chip 17.

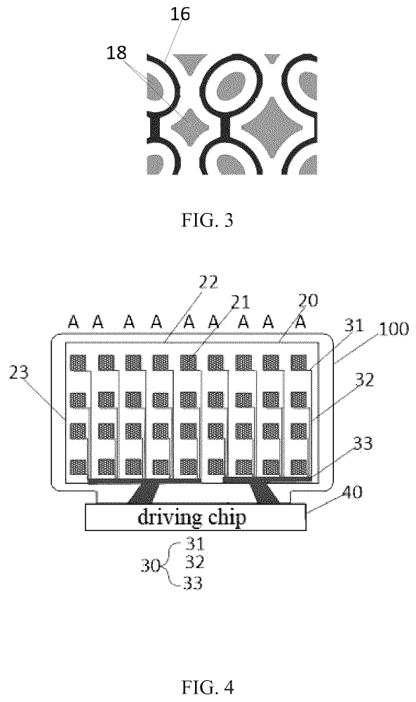

As shown in FIG. 3, the existing touch control leads 16 are located at the gaps between adjacent ones of the sub-pixels 18 and surround a periphery of part of the sub-pixels 18.

Referring to FIGS. 4 to 7, FIG. 4 is a schematic structural diagram of a, touch control module provided by an embodiment of the present application.

As shown in FIG. 4, in one embodiment, the touch control module 100 of the present application includes a touch control layer 20, a plurality of touch control leads 30, and a driving chip 40.

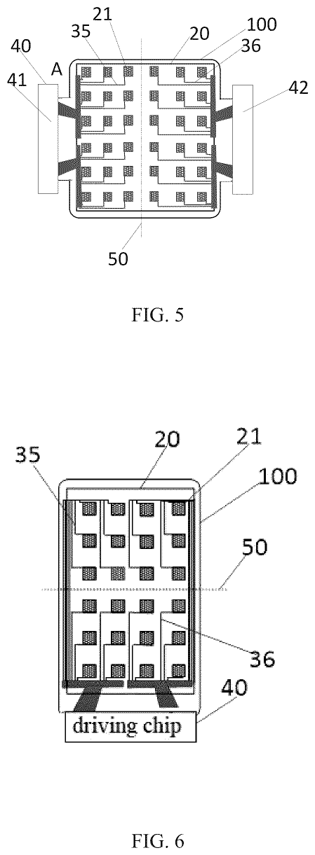

The touch control layer 20 includes a plurality of touch control groups A arranged at intervals; each of the touch control groups A includes a plurality of touch control units 21, and adjacent ones of the touch control units 21 are spaced apart from each other. In one embodiment, the touch control unit 21 has a grid shape. Of course, the structure of the touch control unit 21 is not particularly limited thereto. The touch control unit 21 is made of a metal material and a transparent conductive material, including at least one of copper, aluminum, titanium, and indium tin oxide. In one embodiment, as shown in FIG. 4, the plurality of touch control units in the touch control group A are arranged in a vertical direction, that is, the touch control group A is equivalent to the touch control column. In another embodiment, as shown in FIG. 5, a plurality of touch control units in the touch control group A are arranged in a horizontal direction, that is, the touch control group A is equivalent to the touch control row. In a preferred embodiment, a distance between adjacent ones of the touch control units 21 is smaller than a preset distance. Since the distance between the touch control units 21 is reduced, a space occupied by the touch control leads can be reduced, thereby reducing an area of the blind area and improving the sensitivity of the touch control function.

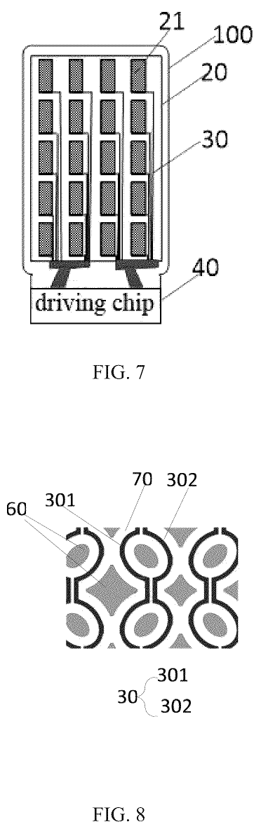

The touch control leads 30 correspond to the touch control units 21, and one end of the touch control lead 30 is connected to the corresponding touch control unit 21. In one embodiment, the touch control leads 30 can be connected to the touch control units 21 in a one-to-one correspondence. A total number of the plurality of setting touch control leads between adjacent ones of the touch control groups A is less than a preset number, and the setting touch control leads are touch control leads arranged in the same direction. Taking FIG. 4 as an example, for example, the touch control leads 30 between adjacent ones of the touch control columns are generally arranged in the vertical direction, and the touch control leads are set to be touch control leads 30 arranged in the vertical direction. The total number of the setting touch control leads between adjacent ones of the touch control columns is 4; and the total number of the setting touch control leads between adjacent ones of the touch control columns in FIG. 2 is 9, It can be seen that the total number of the setting touch control leads between adjacent ones of the touch control columns in FIG. 4 is less than the total number of the setting touch control leads between adjacent ones of the touch control columns in FIG. 2. The structure of FIG. 7 is the same as those in FIGS. 2 and 4, and not repeated herein for brevity.

Taking FIG. 5 as an example, for example, the touch control leads 30 between adjacent ones of the touch control rows are generally arranged to the left or right, and the setting touch control leads are the touch control leads arranged to the left or to the right, and the total number of the setting touch control leads between adjacent ones of the touch control rows is 3. The total number of the setting touch control leads between adjacent ones of the touch control columns in FIG. 2 is 9. The total number of the setting touch control leads between adjacent ones of the touch control rows in FIG. is less than the total number of the setting touch control leads between adjacent ones of the touch control columns in FIG. 2. The structure of 6 is similar to those above, and will not be repeated herein for brevity. Therefore, the space occupied by the touch control leads 30 can be reduced, thereby reducing the area of the blind area and improving the sensitivity of the touch control function. In a preferred embodiment, in order to simplify the manufacturing process, the touch control leads 30 and the touch control units 21 are arranged in the same layer and made of the same material.

The driving chip 40 is connected to another end of the touch control lead 30. In one embodiment, the touch control module of the present application is in a self-capacitive touch control mode. In a specific operating process, the driving chip 40 receives a touch control signal on the touch control unit 21 through the touch control lead 30.

In one embodiment, the touch control lead 30 includes a first connecting portion 31, a trunk portion 32, and a second connecting portion 33, and one end of the trunk portion 32 is connected to a corresponding one of the touch control units through the first connecting portion 31 21, another end of the trunk portion 32 is connected to the drive chip 40 through the second connecting portion 33, the touch control layer 20 includes a setting side 22 and a non-setting side 23; A length of the setting side 22 is greater than a length of the non-setting side 23; that is, the setting side 22 is the long side, and the non-setting side 23 is the short side. An arrangement direction of the trunk portion 32 is same as a direction of the non-setting side 23, that is, the arrangement direction of the trunk portion 32 is arranged along a direction of the short side, wherein an area of the touch control layer 20 is larger than a predetermined area, and the preset area is, for example, 8 inches. Because when the area of the touch control layer 20 is greater than the preset area, if the arrangement direction of the trunk portion 32 is the same as a direction of the long side, there are more touch control leads between adjacent ones of the rows of touch control units, so the area of the blind area is increased. If the arrangement direction of the trunk portion 32 is the same as the direction of the short side, the number of the touch control leads between adjacent ones of the rows of touch control units can be reduced. Therefore, the area of the blind area is reduced, and the sensitivity of the touch control function is improved. It is understandable that the preset area is not particularly limited to 8 inches, and can be specifically set according to requirements.

In one embodiment, in order to further reduce the space occupied by the touch control leads 30, a distance between adjacent ones of the touch control leads 30 is within a preset range. Preferably, the distance between adjacent ones of the touch control leads 30 ranges from 1 um to 100 um. In another embodiment, a width of the touch control lead 30 is smaller than a predetermined width, and the predetermined width may be a width of the existing touch control lead to further reduce the space occupied by the touch control leads 30.

In one embodiment, as shown in FIG. 5 or FIG. 6, the touch control module 100 includes a center line 50, and the center line 50 is arranged along a first direction or a second direction; the first direction intersects the second direction; the center line passes through a geometric center of the touch control layer, or the center line 50 is an axis of the touch control layer.

The first side touch control lead 35 is provided at the first side of the center line 50, wherein the first side touch control lead 35 is the touch control lead 30 corresponding to the touch control unit 21 located at the first side of the center line 50.

The second side touch control lead 36 is arranged at the second side of the center line 50, wherein the second side touch control lead 36 is the touch control lead corresponding to the touch control unit 21 located at the second side of the center line 5. The first side is opposite to the second side. In one embodiment, as shown in FIG. 5, the first side is the left side and the second side is the right side; and in another embodiment, as shown in FIG. 6, the first side is an upper side, and the second side is a lower side.

In a preferred embodiment, in order to reduce the length of the touch control lead 30, one end of the first side touch control lead 35 is connected to the first side of the corresponding touch control unit 21; and one end of the second side touch control lead 36 is connected to the second side of the corresponding touch control unit 21.

In one embodiment, in order to further reduce the length of the touch control lead 30, as shown in FIG. 5, the driving chip 40 includes a first sub-driving chip 41 and a second sub-driving chip 42, wherein the first sub-driving chip 41 is provided at the first side of the touch control layer 20, and the first sub-driving chip 41 is connected to another end of the first side touch control lead 35; the second sub-driving chip 42 is provided at the second side of the touch control layer 20, and the second sub-driving chip 42 is connected to another end of the second side touch control lead 36.

In a preferred embodiment, in order to improve the accuracy of the touch control signal, the first side touch control lead 35 and the second side touch control lead 36 are symmetrically arranged with respect to the center line 50.

In another embodiment, as shown in FIG. 7, the length of the touch control unit 21 is greater than a preset length, and a length direction of the touch control unit 21 is the same as an arrangement direction of the trunk portion 32. The preset length can be a length of an existing touch control unit. In one embodiment, when the trunk portion 32 is arranged along the length direction of the touch control screen 20, the length of the touch control unit 21 (the size in the vertical direction) is increased, thereby reducing a number of the touch control units 21 and a number of the touch control leads 30 in the vertical direction, thus further reducing the total area and space occupied by the touch control leads 30.

In one embodiment, in order to further reduce the space occupied by the touch control leads 30, as shown in FIG. 8, the touch control lead 30 includes a first sub-lead 301 and a second sub-lead 302 spaced apart from each other. The first sub-lead 301 is connected to one of adjacent ones of the touch control units 21. Referring to FIG. 4 to FIG. 7, the second sub-lead 302, is connected to another one of the adjacent ones of the touch control units 21, that is, the touch control lead 30 corresponds to adjacent ones of the touch control units 21.

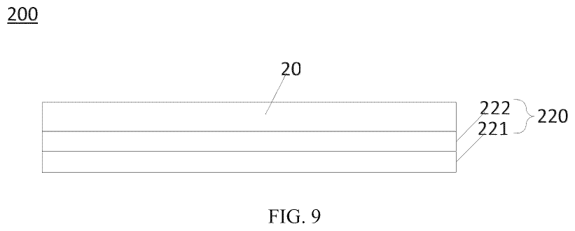

As shown in FIG. 9, the present application also provides a touch control screen 200. The touch control screen 200 includes a display module 220 and any one of the above-described touch control modules. Referring to FIG. 4 to FIG. 7, the display module 220 includes an encapsulation layer 222, and the touch control layer 20 is disposed on the encapsulation layer 222. In addition, the display module 220 may further include a display portion 221 for displaying images. The display portion 221 may be a display panel. In one embodiment, referring to FIG. 8, the display portion 221 may include a plurality of sub-pixels 60 arranged at intervals and a plurality of setting gap regions 70, each of the setting gap regions 70 is located at a gap between adjacent ones of the sub-pixels 60, and the setting gap regions 70 surround the peripheries of a part of the sub-pixels 60.

The first sub-lead 301 is provided at the first side of the setting gap region the second sub-lead 302 is provided at the second side of the setting gap region 70. For example, the first sub-lead 301 is provided at the left side of the setting gap region and the second sub-lead 302 is provided at the right side of the setting gap region 70. The first sub-lead 301 and the second sub-lead 302 can be spaced apart from each other. Compared with FIG. 3, two sub-leads are arranged at a position where the existing touch control leads are located, thereby reducing the total number of the touch control leads and the space occupied by the touch control leads.

The present application also provides an electronic device, which includes the aforementioned touch control screen 200. The electronic equipment includes, but is not particularly limited to, mobile phones, tablet computers, computer monitors, game consoles, televisions, wearable devices, and other household appliances or household appliances with display functions.

Each of the touch control module, touch control screen, and electronic device of the present application includes a touch control layer, wherein the touch control layer includes a plurality of touch control groups arranged at intervals, each of the touch control groups includes a plurality of touch control units, and adjacent ones of the touch control units are spaced apart from each other; a plurality of touch control leads, wherein the touch control leads correspond to the touch control units, one end of one of the touch control leads is connected to a corresponding one of the touch control units, a total number of a plurality of setting touch control leads between adjacent ones of the touch control groups is less than a preset number, and the setting touch control leads are touch control leads arranged in a same direction; and a driving chip connected with another end of the one of the touch control leads, such that a space occupied by the touch control leads can be reduced, and thereby an area of a blind area is reduced, thus improving the sensitivity of the touch control function.

The flexible display panel touch control module, the touch control screen, and the electronic device provided by the present application have been described in detail above. Specific examples are used in this document to explain the principles and implementation of the present invention. The descriptions of the above embodiments are only for understanding the method of the present invention and its core idea; Meanwhile, for those skilled in the art, according to the idea of the present invention, there will be changes in the specific implementation and application scope. In summary, the content of this specification should not be construed as a limitation on the present invention.

What is claimed is:

1. A touch control module, comprising:
a touch control layer, wherein the touch control layer comprises a plurality of touch control groups arranged at intervals, each of the touch control groups comprises a plurality of touch control units, and adjacent ones of the touch control units are spaced apart from each other;
a plurality of touch control leads, wherein the touch control leads correspond to the touch control units, one end of one of the touch control leads is connected to a corresponding one of the touch control units, a total number of a plurality of setting touch control leads between adjacent ones of the touch control groups is less than a preset number, and the setting touch control leads are touch control leads arranged in a same direction; and
a driving chip connected with another end of the one of the touch control leads.

2. The touch control module according to claim 1, wherein each of the touch control leads comprises a first connecting portion, a second connecting portion, and a trunk portion, one end of the trunk portion is connected to a corresponding one of the touch control units through the first connecting portion, and another end of the trunk portion is connected to the driving chip through the second connecting portion; and
wherein a length of each of the touch control units is greater than a preset length, and a length direction of the touch control units is same as an arrangement direction of the trunk portion.

3. The touch control module according to claim 1, wherein a distance between adjacent ones of the touch control leads is within a predetermined range.

4. The touch module of claim 3, wherein the distance between adjacent ones of the touch control leads ranges from 1 um to 100 um.

5. The touch control module according to claim 1, wherein the touch control module comprises a center line, the center line is arranged along a first direction or a second direction, and the first direction intersects the second direction;
wherein a first side touch control lead is provided at a first side of the center line, and the first side touch control lead is a touch control lead corresponding to one of the touch control units located at the first side of the center line; and
wherein a second side touch control lead is arranged at a second side of the center line, the second side touch control lead is a touch control lead corresponding to one of the touch control units located at the second side of the center line, and the first side is opposite the second side.

6. The touch control module according to claim 5, wherein
one end of the first side touch control lead is connected to the first side of a corresponding one of the touch control units;
one end of the second side touch control leads is connected to the second side of a corresponding one of the touch control units.

7. The touch control module according to claim 5, wherein the driving chip comprises:
a first sub-driving chip arranged on a first side of the touch control layer, and the first sub-driving chip is connected to another end of the first side touch control lead; and
a second sub-driving chip arranged on a second side of the touch control layer, and the second sub-driving chip is connected to another end of the second side touch control lead.

8. The touch control module according to claim 7, wherein the first side touch control lead and the second side touch control lead are symmetrically arranged with respect to the center line.

9. The touch control module according to claim 1, wherein each of the touch control leads comprises:
a first sub-lead connected to one of the adjacent ones of the touch control units; and
a second sub-lead spaced apart from the first sub-lead, wherein the second sub-lead is connected to another one of the adjacent ones of the touch control units.

10. The touch control module according to claim 1, wherein
a distance between adjacent ones of the touch control units is smaller than a preset distance.

11. The touch control module according to claim 1, wherein each of the touch control leads comprises a first connecting portion, a second connecting portion, and a trunk portion, one end of the trunk portion is connected to a corresponding one of the touch control units through the first connecting portion, and another end of the trunk portion is connected to the driving chip through the second connecting portion; and
wherein the touch control layer comprises a setting side and a non-setting side, a length of the setting side is greater than a length of the non-setting side; an arrangement direction of the trunk portion is same as a direction of the non-setting side, and an area of the touch control layer is greater than a preset area.

12. The touch control module according to claim 1, wherein
the touch control leads and the touch control units are arranged in a same layer and made of a same material.

13. The touch control module according to claim 1, wherein
a width of the touch control lead is smaller than a preset width.

14. A touch control display screen, comprising:
a display module, comprising a packaging layer; and
the touch control module according to claim 1, and the touch control layer is provided on the packaging layer.

15. The touch control display screen according to claim 14, wherein
the display module further comprises a display portion, the display portion comprises a plurality of sub-pixels disposed at intervals and a plurality of setting gap regions, each of the setting gap regions is located at a gap between adjacent ones of the sub-pixels, and the setting gap regions surround a periphery of a part of the sub-pixels;
the first sub-lead is arranged at a first side of one of the setting gap regions; and
the second sub-lead is arranged at a second side of one of the setting gap regions.

16. The touch control display screen according to claim 14, wherein
each of the touch control leads comprises a first connecting portion, a second connecting portion, and a trunk portion, one end of the trunk portion is connected to a corresponding one of the touch control units through the first connecting portion, and another end of the trunk portion is connected to the driving chip through the second connecting portion; and
wherein a length of each of the touch control units is greater than a preset length, and a length direction of the touch control units is same as an arrangement direction of the trunk portion.

17. The touch control display screen according to claim 14, wherein a distance between adjacent ones of the touch control leads is within a predetermined range.

18. The touch control display screen according to claim 14, wherein the touch control module comprises a center line, the center line is arranged along a first direction or a second direction, and the first direction intersects the second direction;
wherein a first side touch control lead is provided at a first side of the center line, and the first side touch control lead is a touch control lead corresponding to one of the touch control units located at the first side of the center line; and
wherein a second side touch control lead is arranged at a second side of the center line, the second side touch control lead is a touch control lead corresponding to one of the touch control units located at the second side of the center line, and the first side is opposite the second side.

19. The touch control display screen according to claim 14, wherein each of the touch control leads comprises a first connecting portion, a second connecting portion, and a trunk portion, one end of the trunk portion is connected to a corresponding one of the touch control units through the first connecting portion, and another end of the trunk portion is connected to the driving chip through the second connecting portion; and
wherein the touch control layer comprises a setting side and a non-setting side, a length of the setting side is greater than a length of the non-setting side; an arrangement direction of the trunk portion is same as a direction of the non-setting side, and an area of the touch control layer is greater than a preset area.

20. An electronic device, comprising the touch control display screen according to claim 14.
